(19) United States
(12) Patent Application Publication
(10) Pub. No.: US 2015/0118455 A1
(43) Pub. Date: Apr. 30, 2015

(54) INTERMEDIATE BASE MATERIAL FILM AND TOUCH PANEL SENSOR

(71) Applicant: DAI NIPPON PRINTING CO., LTD., Tokyo (JP)

(72) Inventors: Koujirou OOKAWA, Tokyo (JP); Takashi KURODA, Tokyo (JP)

(21) Appl. No.: 14/526,917

(22) Filed: Oct. 29, 2014

Related U.S. Application Data
(63) Continuation of application No. 14/525,517, filed on Oct. 28, 2014.

(30) Foreign Application Priority Data
Oct. 28, 2013 (JP) 2013-223486

(51) Int. Cl. G06F 3/041; G06F 3/044

(52) U.S. Cl. CPC G06F 3/0412; G06F 3/044
USPC 428/201; 428/212; 428/216; 428/195.1

(57) ABSTRACT

There is provided an intermediate base material film including: a transparent base material; a transparent layer having a refractive index of from 1.47 to 1.57 and a film thickness of 1 μm or more; a high-refractive-index layer having a refractive index of from 1.62 to 1.72 and a film thickness of from 20 nm to 80 nm; and a low-refractive-index layer having a refractive index of from 1.44 to 1.54 and a film thickness from of 3 nm to 45 nm, wherein when the intermediate base material film is irradiated with light to determine a* and b* values in a L*a*b* color system from reflected light toward each regular reflection direction, a variation of the a* values is 1.0 or less, and a variation of the b* values is 1.6 or less.

### BACKGROUND OF THE INVENTION

1. Field of the Invention

The present invention relates to an intermediate base material film and a touch panel sensor.

2. Description of the Related Art

Nowadays, touch panel devices are widely used as input means. Such a touch panel device includes a touch panel sensor, a control circuit which detects a contact position on the touch panel sensor, a wiring line, and an FPC (flexible print circuit). The touch panel devices are often used as input means for various devices, into which display devices such as liquid crystal displays and plasma displays are incorporated, and the like (e.g., ticket vendors, ATM devices, mobile phones, and gaming machines), together with display devices. In such a device, a touch panel sensor is placed on the display surface of a display device, to thereby enable extremely direct input into the display device.

The touch panel devices are classified into various types according to the principle of detecting a contact position (approach position) on a touch panel sensor. Recent interest has focused on capacitive-type touch panel devices for the reasons of being optically bright; having designing properties and simple structures; being functionally excellent; and the like. Capacitive types include surface types and projection types. The projection types have received attention because of being suitable for supporting multi-touch recognition (multi-point recognition).

Touch panel sensors in projection-type capacitive-type touch panels include a touch panel sensor including an intermediate base material film and a transparent conductive layer formed on the intermediate base material film (e.g., see Japanese Patent Laid-Open No. 2011-98563).

The larger areas of touch panel devices have currently proceeded. However, the larger area of such a touch panel device results in a larger screen size and therefore in a tendency for a viewing angle to greatly vary according to a location where the touch panel device is viewed. The intermediate base material film of a touch panel sensor used in a touch panel device is designed based on the premise of being viewed from the front; however, such a design philosophy based on the premise of being viewed from the front might be incapable of supporting the larger area of the touch panel device since a tint varies according to a viewing angle.

The present invention was accomplished to solve the problems described above. In other words, an object of the present invention is to provide an intermediate base material film and a touch panel sensor, in which a variation of tints can be suppressed in the case of viewing from various angles.

### SUMMARY OF THE INVENTION

In accordance with one embodiment of the present invention, there is provided an intermediate base material film for supporting a conductive layer subjected to patterning, the intermediate base material including: a transparent base material; a first transparent layer that is layered on one surface of the transparent base material and has a refractive index of 1.47 or more and 1.57 or less and a film thickness of 1 μm or more; a first high-refractive-index layer that is layered on the first transparent layer and has a refractive index of 1.62 or more and 1.72 or less and a film thickness of 20 nm or more and 80 nm or less; and a first low-refractive-index layer that is layered on the first high-refractive-index layer and has a refractive index of 1.44 or more and 1.54 or less and a film thickness of 3 nm or more and 45 nm or less, wherein when the intermediate base material film is irradiated with light from a first low-refractive-index layer side while an incidence angle is varied every five degrees in a range of 0° or more and 75° or less, assuming that a normal direction of a surface of the intermediate base material film is 0°, to determine a* and b* values in a L*a*b* color system from reflected light toward each regular reflection direction, a variation of the a* values is 1.0 or less, and a variation of the b* values is 1.6 or less.

The intermediate base material film described above may further include a second transparent layer that is layered on a surface opposite to the one surface of the transparent base material and has a refractive index of 1.47 or more and 1.57 or less and a film thickness of 1 μm or more; a second high-refractive-index layer that is layered on the second transparent layer and has a refractive index of 1.62 or more and 1.72 or less and a film thickness of 20 nm or more and 80 μm or less; and a second low-refractive-index layer that is layered on the second high-refractive-index layer and has a refractive index of 1.44 or more and 1.54 or less and a film thickness of 3 nm or more and 45 nm or less.

In accordance with another embodiment of the present invention, there is provided a touch panel sensor including: the intermediate base material film described above; and a first conductive layer that is layered on the first low-refractive-index layer of the intermediate base material film and is subjected to patterning.

In accordance with another embodiment of the present invention, there is provided a touch panel sensor including: the intermediate base material film described above; a first conductive layer that is layered on the first low-refractive-index layer of the intermediate base material film and is subjected to patterning; and a second conductive layer that is layered on the second low-refractive-index layer of the intermediate base material film and is subjected to patterning.

According to the intermediate base material film and the touch panel sensor of one embodiment of the present invention, a variation of tints can be suppressed in the case of viewing from various angles.

### BRIEF DESCRIPTION OF THE DRAWINGS

FIG. 1 is a schematic view illustrating the configuration of an intermediate base material film according to a first embodiment;

FIG. 2 is a schematic view illustrating a state in which a* and b* in an intermediate base material film is measured using a spectrophotometer;

FIG. 3 is a schematic view illustrating the configuration of a touch panel sensor according to the first embodiment;

FIG. 4 is a plan view of a portion of the first conductive layer illustrated in FIG. 3;

FIG. 5 is a plan view of a portion of the second conductive layer illustrated in FIG. 3;

FIG. 6 is a schematic view illustrating the configuration of another touch panel sensor according to the first embodiment;

FIG. 7 is a schematic view illustrating the configuration of an intermediate base material film according to a second embodiment; and

FIG. 8 is a schematic view illustrating the configuration of a touch panel sensor according to the second embodiment.

### DETAILED DESCRIPTION OF THE PREFERRED EMBODIMENTS

### First Embodiment

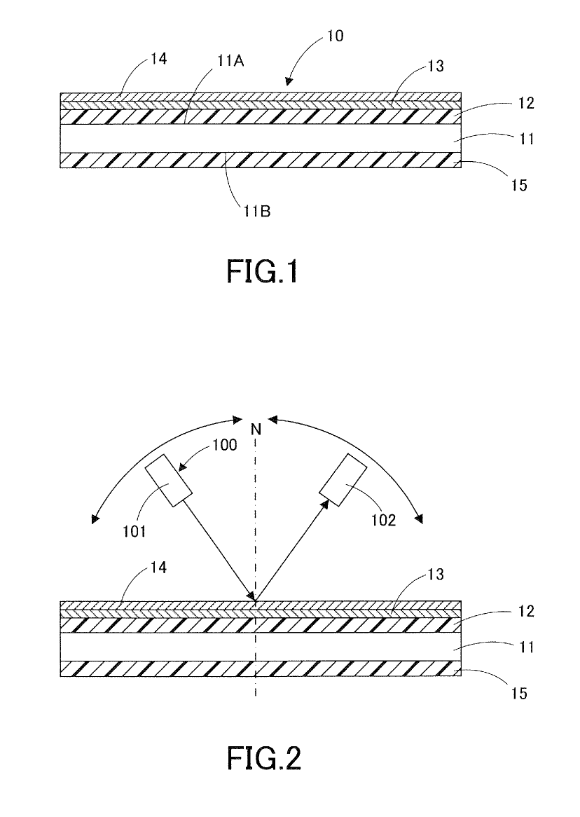

The intermediate base material film and the touch panel sensor according to the first embodiment of the present invention will be described below with reference to the drawings. FIG. 1 is a schematic view illustrating the configuration of the intermediate base material film according to the present embodiment, and FIG. 2 is a schematic view illustrating a state in which the spectral reflectance of the intermediate base material film is measured with a spectral reflectance measuring device. As used herein, the terms “film”, “sheet”, “plate”, and the like are based only on difference in name and are not distinguished from each other. Thus, for example, “film” is a concept also including members that can also be referred to as sheets and plates. As a specific example, “intermediate base material film” includes a member referred to as “intermediate base material sheet” or the like.

<<Intermediate Base Material Film>>

The intermediate base material film is intended to support a conductive layer subjected to patterning. For example, when “intermediate base material film” incorporated into a device such as a touch panel is used, “intermediate base material film” does not mean a base material film used in an outermost surface of the device such as a touch panel but means a base material film used in the interior of the device such as a touch panel.

The intermediate base material film 10 illustrated in FIG. 1 includes: a transparent base material 11; a first transparent layer 12 formed on one surface 11A of the transparent base material 11; a first high-refractive-index layer 13 formed on the first transparent layer 12; a first low-refractive-index layer 14 formed on the high-refractive-index layer 13; and a second transparent layer 15 formed on a surface 11B opposite to the one surface 11A of the transparent base material 11.

The intermediate base material film 10 includes the second transparent layer 15. However, the intermediate base material film 10 does not necessarily include the second transparent layer 15. The intermediate base material film may also include a second high-refractive-index layer or a second low-refractive-index layer on the second transparent layer. Specifically, the intermediate base material film may be the intermediate base material film 10 illustrated in FIG. 1 or may be any of: an intermediate base material film in which a first transparent layer, a first high-refractive-index layer, and a first low-refractive-index layer are disposed in the mentioned order on one surface of a transparent base material and a second transparent layer is not disposed on the other surface of the transparent base material; an intermediate base material film in which a first transparent layer, a first high-refractive-index layer, and a first low-refractive-index layer are disposed in the mentioned order on one surface of a transparent base material and a second transparent layer and a second high-refractive-index layer are disposed in the mentioned order on the other surface of the transparent base material; and an intermediate base material film in which a first transparent layer, a first high-refractive-index layer, and a first low-refractive-index layer are disposed in the mentioned order on one surface of a transparent base material and a second transparent layer, a second high-refractive-index layer, and a second low-refractive-index layer are disposed in the mentioned order on the other surface of the transparent base material.

In the intermediate base material film 10, when the intermediate base material film 10 is irradiated with light from a side of the first low-refractive-index layer 14 while an incidence angle is varied every five degrees in a range of 0° or more and 75° or less, assuming that the normal direction of a surface of the intermediate base material film 10 is 0°, to determine a* and b* values in a L*a*b* color system from reflected light toward each regular reflection direction, a variation of the a* values is 1.0 or less, and a variation of the b* values is 1.6 or less. “L*a*b* color system”, “a*”, and “b*” are based on JIS Z8729.

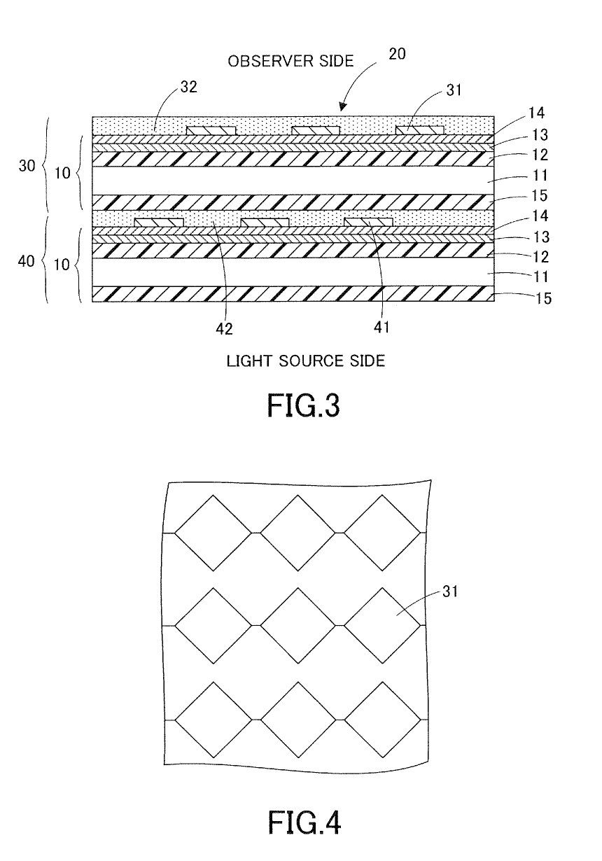

The a* and b* values are measured based on JIS 28722 and can be specifically determined, for example, using a known spectrophotometer. A spectrophotometer 100 illustrated in FIG. 3 includes: a light source 101 which can be moved in a range of 0° or more and 75° or less; and a detector 102 which moves in synchronization with the movement of the light source to be able to receive reflected light in a regular reflection direction. The movement angle of the light source 101 is based on the normal direction N of the intermediate base material film 10 as 0°. The intermediate base material film 10 is irradiated with light from the light source 101, reflected light in a regular reflection direction is received by the detector 102, and the a* and b* values can be determined from the reflected light received by the detector 102. When it is difficult to determine a* and b* values at an incidence angle of 0° by the spectrophotometer, the a* and b* values at an incidence angle of 0° may be determined in simulation. Examples of the spectrophotometer include an absolute reflectance measurement apparatus VAR-7010 and an ultraviolet-visible near-infrared spectrophotometer V-7100, manufactured by JASCO Corporation. Examples of the light source include a single tungsten halogen (WI) lamp and a combination of a deuterium (D2) lamp and a tungsten halogen (WI) lamp. In this measurement, a difference between the reflectances of s-polarized light and p-polarized light is increased with increasing an incidence angle, and therefore, use of a polarizer of which the transmission axis is inclined at 45° is preferred for accurate measurement.

The variations of the a* and b* values can be determined by determining a* and b* values at each incidence angle with the spectrophotometer described above and calculating the absolute value of the difference between the maximum and minimum values thereof. The variation of the a* values is preferably 0.4 or less, and the variation of the b* values is preferably 1.55 or less.

A color difference ΔE*ab between reflected light at a certain angle where the a* and b* values described above are determined and reflected light at another angle where the a* and b* values described above are determined is preferably 5 or less. “ΔE*ab” is based on JIS Z8730.

<Transparent Base Material>

The transparent base material 11 is not particularly limited as long as the transparent base material 11 has light transmissiveness, and examples thereof include polyolefin base materials, polycarbonate base materials, polyacrylate base materials, polyester base materials, aromatic polyether ketone base materials, polyethersulfone base materials, and polyimide base materials.

Examples of the polyolefin base materials include a base material containing as a constituent at least one of polyethylene, polypropylene, and cyclic polyolefin base materials, and the like. Examples of the cyclic polyolefin base materials include a base material having a norbornene skeleton.

Examples of the polycarbonate base materials include aromatic polycarbonate base materials based on bisphenols (such as bisphenol A) and aliphatic polycarbonate base materials based on diethylene glycol bis(allyl carbonate) and the like.

Examples of the polyacrylate base materials include poly(methyl (meth)acrylate) base materials, polyethyl (meth)acrylate) base materials, methyl (meth)acrylate-butyl (meth)acrylate copolymer base materials, and the like.

Examples of the polyester base materials include a base material containing as a constituent at least one of polyethylene terephthalate (PET), polypropylene terephthalate, polybutylene terephthalate, and polyethylene naphthalate (PEN).

Examples of the aromatic polyether ketone base materials include polyether ether ketone (PEEK) base materials and the like.

The thickness of the transparent base material 11 is not particularly limited but can be 5 μm or more and 300 μm or less. The lower limit of the thickness of the transparent base material 11 is preferably 25 μm or more, more preferably 50 μm or more, from the viewpoint of handleability and the like. The upper limit of the thickness of the transparent base material 11 is preferably 250 m or less from the viewpoint of thinning.

In addition to physical treatment such as corona discharge treatment or oxidation treatment, a coating called an anchoring agent or a primer may be pre-applied to a surface of the transparent base material 11 in order to improve adhesiveness. As the anchoring agent or the primer agent, for example, there can be used at least one of polyurethane resins, polyester resins, polyvinyl chloride resins, polyvinyl acetate resins, vinyl chloride-vinyl acetate copolymers, acryl resins, polyvinyl alcohol resins, polyvinyl acetal resins, copolymers of ethylene with vinyl acetate, acrylic acid, and the like, copolymers of ethylene with styrene, butadiene, and/or the like, thermoplastic resins, such as olefin resins, and/or modified resins thereof, polymers of photopolymerizable compounds, thermosetting resins such as epoxy resins, and the like.

<First Transparent Layer and Second Transparent Layer>

The first transparent layer 12 and the second transparent layer 15 in the present embodiment preferably have hard coat properties. When the first transparent layer 12 and the second transparent layer 15 have the hard coat properties, the first transparent layer 12 and the second transparent layer 15 have a hardness of “II” or more on the pencil hardness test (load of 4.9 N) defined in JIS K5600-5-4 (1999). By allowing the pencil hardness to be “II” or more, a surface of the first low-refractive-index layer 14 can be allowed to sufficiently reflect the hardness of the first transparent layer 12, and durability can be improved. The upper limit of the pencil hardness of the surface of the first transparent layer 12 is preferably allowed to be around 4 H from the viewpoint of adhesiveness with the first high-refractive-index layer 13 formed on the first transparent layer 12, toughness, and prevention of curl. Since the touch panel sensor, which is repeatedly pressed, requires high adhesiveness and toughness, a prominent effect can be exerted by allowing the upper limit of the pencil hardness of the first transparent layer 12 to be 4 H when the intermediate base material film 10 incorporated into the touch panel sensor is used. Heating of the intermediate base material film accompanies formation of a conductive layer on the first low-refractive-index layer 14. A problem that an oligomer is precipitated from the transparent base material due to the heating and the haze of the intermediate base material film is increased may occur. However, the first transparent layer 12 and the second transparent layer 15 can function as layers that suppress the precipitation of an oligomer.

The first transparent layer 12 has a refractive index of 1.47 or more and 1.57 or less. The lower limit of the refractive index of the first transparent layer 12 is preferably 1.50 or more, and the upper limit of the refractive index of the first transparent layer 12 is preferably 1.54 or less. It is preferable that the refractive index of the second transparent layer 15 is also in the same range as that of the first transparent layer 12. However, the refractive index of the second transparent layer 15 is not necessarily equal to the refractive index of the first transparent layer 12.

The refractive indices of the first transparent layer 12 and the second refractive index layer 15 can be measured with an Abbe refractometer (NAR-4T, manufactured by ATAGO CO., LTD.) or an ellipsometer, following the formation of a single layer. Examples of an applicable method of measuring the refractive index following the formation of the intermediate base material film 10 include a method of shaving off each of the first transparent layer 12 and the second refractive index layer 15 using a cutter or the like, to prepare a powdery sample, and then performing the Becke method on the sample in conformity with the B method in HS K7142 (2008) (for powdery or granular transparent materials). The Becke method is a method including: placing the powdery sample on a slide glass or the like; dripping a Cargille reagent with a known refractive index onto the sample to immerse the sample in the reagent; microscopically observing the state of immersion; determining the refractive index of a reagent that provides no bright line (Becke line), which occurs along the sample outline when the sample and the reagent have different refractive indices, in the visual observation; and regarding the determined refractive index as the refractive index of the sample.

The first transparent layer 12 has a film thickness of 1.0 μm or more. When the thickness of the first transparent layer 12 is 1.0 μm or more, desired hardness can be obtained. The film thickness of the first transparent layer 12 can be measured by sectioning microscopy. The lower limit of the thickness of the first transparent layer is more preferably 1.5 μm or more while the upper limit thereof is more preferably 7.0 μm or less. The thickness of the first transparent layer 12 is still more preferably 2.0 μm or more and 5.0 μm or less. The film thickness of the second transparent layer 15 is preferably in the same range as that of the film thickness of the first transparent layer 12. However, the film thickness of the second transparent layer 15 is not necessarily equal to the film thickness of the first transparent layer 15.

The first transparent layer 12 and the second transparent layer 15 may include, for example, a resin. The resin contains a polymer (crosslinked substance) of a photopolymerizable compound. The resin may also contain a solvent drying type resin and a thermosetting resin, in addition to the polymer (crosslinked substance) of the photopolymerizable compound. The photopolymerizable compound has at least one photopolymerizable functional group. As used herein, “photopolymerizable functional group” refers to a functional group that can be polymerized by light irradiation. Examples of the photopolymerizable functional group include groups having an ethylenic double bond, such as (meth)acryloyl groups, vinyl groups, and allyl groups. “(Meth)acryloyl groups” means both of “acryloyl group” and “methacryloyl group”. Examples of the light that is irradiated when the photopolymerizable compound is polymerized include visible light rays and ionizing radiations such as ultraviolet rays, X-rays, electron rays, α-rays, β-rays, and γ-rays.

Examples of the photopolymerizable compound include photopolymerizable monomers, photopolymerizable oligorners, or photopolymerizable polymers, which may be appropriately adjusted to be used. As the photopolymerizable compound, a combination of a photopolymerizable monomer with a photopolymerizable oligomer or a photopolymerizable polymer is preferred.

Photopolymerizable Monomer

A photopolymerizable monomer has a weight average molecular weight of less than 1000. As the photopolymerizable monomer, a polyfunctional monomer having two (i.e., bifunctional) or more photopolymerizable functional groups is preferred. As used herein, “weight average molecular weight” is a value obtained by dissolution in a solvent such as tetrahydrofuran (THF), and by polystyrene conversion by a gel permeation chromatography (GPC) method known in the art.

Examples of bi- or multi-functional monomers include trimethylolpropane tri(meth)acrylate, tripropylene glycol di(meth)acrylate, diethyl ene glycol di (meth)acrylate, dipropylene glycol di(meth)acrylate, pentaerythritol tri(meth)acrylate, pentaerythritol tetra(meth)acrylate, dipentaerythritol hexa(meth)acrylate, 1,6-hexanediol di(meth)acrylate, neopentyl glycol di(meth)acrylate, trimethylolpropane tri (meth)acrylate, ditrimethylolpropane tetra(meth)acrylate, dipentaerythritol penta(meth)acrylate, tripentaerythritol octa(meth)acryl ate, tetrapentaerythritol deca(meth)acrylate, isocyanuric acid tri(meth)acrylate, isocyanuric acid di(meth)acrylate, polyester tri(meth)acrylate, polyester di(meth)acrylate, bisphenol di(meth)acrylate, diglycerol tetra(meth)acrylate, adamanthyl di(meth)acrylate, isobornyl di(meth)acrylate, dicyclopentane di(meth)acrylate, tricyclodecane di(meth)acrylate, and ditrimethylolpropane tetra(meth)acrylate, and monomers obtained by modifying them with PO, EO, and the like.

Among them, pentaerythritol triacrylate (PETA), dipentaerythritol hexaacrylate (DPHA), pentaerythritol tetraacrylate (PETTA), dipentaerythritol pentaacrylate (DPPA), and the like are preferred from the viewpoint of obtaining a hard coat layer having high hardness.

Photopolymerizable Oligomer

A photopolymerizable oligomer has a weight average molecular weight of 1000 or more and less than 10000. As such photopolymerizable oligomers, bi- or multi-functional polyfunctional oligomers are preferred. Examples of the polyfunctional oligomers include polyester (meth)acrylates, urethane (meth)acrylates, polyester-urethane (meth)acrylates, polyether (meth)acryl ates, polyol (meth)acrylates, melamine (meth)acrylates, isocyanurate (meth)acrylates, epoxy (meth)acrylates, and the like.

Photopolymerizable Polymer

A photopolymerizable polymer has a weight average molecular weight of 10000 or more, and the weight average molecular weight is preferably 10000 or more and 80000 or less, more preferably 10000 or more and 40000 or less. When the weight average molecular weight is more than 80000, coating suitability might be deteriorated due to high viscosity to deteriorate the appearance of an obtained optical film. Examples of the above-described polyfunctional polymer include urethane (meth)acrylates, isocyanurate (meth)acrylates, polyester-urethane (meth)acrylates, epoxy (meth)acrylates, and the like.

When the photopolymerizable compound is polymerized (crosslinked), a polymerization initiator may be used. The polymerization initiator is a constituent that is decomposed by light irradiation, generates a radical, and causes the initiation or progress of the polymerization (crosslinking) of a photopolymerizable compound.

The polymerization initiator is not particularly limited as long as the polymerization initiator can release a substance that initiates radical polymerization by light irradiation. Known polymerization initiators can be used without particular limitation. Specific examples of the polymerization initiators include acetophenones, benzophenones, Michler's benzoyl benzoate, α-amyloxime ester, thioxanthones, propiophenones, benzyls, benzoins, and acylphosphine oxides. Further, it is preferable to mix and use a photosensitizer, and specific examples thereof include n-butylamine, triethylamine, poly-n-butylphosphine, and the like.

As the above-described polymerization initiator, acetophenones, benzophenones, thioxanthones, benzoins, benzoin methyl ether, and the like are preferably used singly or in combination, when the above-described binder resin is a resin system having a radical polymerizable unsaturated group.

The solvent drying type resin, such as a thermoplastic resin, is such a resin as to become a coating only by drying a solvent added to adjust a solid content during coating. In the case of adding the solvent drying type resin, any defect in a coating on a surface coated with a coating fluid can be effectively prevented when the antiglare layer 12 is formed. As the solvent drying type resin, without particular limitation, a thermoplastic resin can be typically used.

Examples of the thermoplastic resin include styrenic resins, (meth)acrylic resins, vinyl acetate resins, vinyl ether resins, halogen-containing resins, alicyclic olefinic resins, polycarbonate resins, polyester resins, polyamide resins, cellulose derivatives, silicone resins, and rubbers or elastomers.

Preferably, the thermoplastic resin is noncrystalline and is soluble in an organic solvent (particularly a common solvent in which a plurality of polymers or curable compounds can be dissolved). From the viewpoint of transparency and weather resistance, particularly preferred are styrenic resins, (meth)acrylic resins, alicyclic olefinic resins, polyester resins, cellulose derivatives (such as cellulose esters), and the like.

Examples of the thermosetting resin include, but are not particularly limited to, phenol resins, urea resins, diallyl phthalate resins, melamine resins, guanamine resins, unsaturated polyester resins, polyurethane resins, epoxy resins, aminoalkyd resins, melamine-urea cocondensed resins, silicone resins, polysiloxane resins, and the like.

The first transparent layer 12 and the second transparent layer 15 can be formed by applying a composition for a transparent layer, containing the above-described photopolymerizable compound, to the surface of the transparent base material 11, drying the composition, and then irradiating the coating film-like composition for a transparent layer with light such as ultraviolet light, to polymerize (crosslink) the photopolymerizable compound.

In addition to the above-described photopolymerizable compound, a solvent and a polymerization initiator may be optionally added to the composition for a transparent layer. Further, a dispersing agent, a surfactant, an antistatic agent, a silane coupling agent, a thickener, a coloring inhibitor, a coloring agent (a pigment, a dye), an antifoaming agent, a leveling agent, a flame retardant, an ultraviolet absorbing agent, an adhesion-imparting agent, a polymerization inhibitor, an oxidation inhibitor, a surface modifier, a lubricant, or the like, known in the art, may also be added to the composition for transparent layer depending on a purpose such as increase in the hardness of the first transparent layer, suppression of shrinkage on curing, or control of a refractive index.

Examples of methods for applying a composition for a transparent layer include known application methods such as spin coating, dip methods, spray methods, slide coating methods, bar coating methods, roll coating methods, gravure coating methods, and die coating methods.

When ultraviolet light is used as light for curing a composition for a transparent layer, there can be used ultraviolet light emitted from ultra-high-pressure mercury lamps, high-pressure mercury lamps, low-pressure mercury lamps, carbon-arc, xenon-arc and metal halide lamps, and the like. Further, a wavelength region of 190 to 380 nm may be used for the wavelength of the ultraviolet light. Specific examples of electron beam sources include various electron beam accelerators such as Cockcroft-Walton accelerators, Van de Graaff accelerators, resonance transformer accelerators, insulated core transformer accelerators, linear accelerators, Dynamitron accelerators, and high-frequency accelerators.

<First High-Refractive-Index Layer>

The first high-refractive-index layer 13 is a layer having a higher refractive index than the refractive index of the first transparent layer 12. Specifically, the refractive index of the first high-refractive-index layer 13 is 1.62 or more and 1.72 or less. The lower limit of the refractive index of the first high-refractive-index layer 13 is preferably 1.65 or more, and the upper limit of the refractive index of the first high-refractive-index layer 13 is preferably 1.69 or less. The refractive index of the First high-refractive-index layer 13 can be measured by a method similar to the method for measuring the refractive index of the first transparent layer 12 described above. The difference between the refractive indices of the first transparent layer 12 and the first high-refractive-index layer 13 is preferably 0.05 or more and 0.15 or less from the viewpoint of more suppressing a variation of tints.

The film thickness of the first high-refractive-index layer 13 is 20 nm or more and 80 nm or less. The lower limit of the film thickness of the first high-refractive-index layer 13 is preferably 40 nm or more, and the upper limit of the refractive index of the first high-refractive-index layer 13 is preferably 60 nm or less.

The first high-refractive-index layer 13 and the first low-refractive-index layer 14 can function as index matching layers for decreasing the differences between the light transmittances and reflectances of a region where a conductive layer is disposed and a region where a conductive layer is not disposed.

The first high-refractive-index layer 13 is not particularly limited as long as the first high-refractive-index layer 13 has the above-described refractive index and the above-described film thickness. The first high-refractive-index layer 13 can include, for example, high-refractive-index particles and a binder resin.

Examples of the high-refractive-index particles described above include fine metal oxide particles. Specific examples of the fine metal oxide particles include titanium oxide (TiO₂, refractive index: 2.3 to 2.7), niobium oxide (Nb₂O₅, refractive index: 2.33), zirconium oxide (ZrO₂, refractive index: 2.10), antimony oxide (Sb₂O₅, refractive index: 2.04), tin oxide (SnO₂, refractive index: 2.00), tin-doped indium oxide (ITO, refractive index: 1.95 to 2.00), cerium oxide (CeO₂, refractive index: 1.95), aluminum-doped zinc oxide (AZO, refractive index: 1.90 to 2.00), gallium-doped zinc oxide (GZO, refractive index: 1.90 to 2.00), zinc antimonate (ZnSb₂O₆, refractive index: 1.90 to 2.00), zinc oxide (ZnO, refractive index: 1.90), yttrium oxide (Y₂O₃, refractive index: 1.87), antimony-doped tin oxide (ATO, refractive index: 1.75 to 1.85), phosphorus-doped tin oxide (PTO, refractive index: 1.75 to 1.85), and the like. Of these, zirconium oxide is preferred from the viewpoint of a higher refractive index and a cost.

As the binder resin contained in the first high-refractive-index layer 13, a thermoplastic resin can also be used without particular limitation. From the viewpoint of increasing surface hardness, a polymer (crosslinked substance) of a thermosetting resin, a photopolymerizable compound, or the like is preferred, and especially, a polymer of a photopolymerizable compound is more preferred.

Examples of thermosetting resins include resins such as acryl resins, urethane resins, phenolic resins, urea melamine resins, epoxy resins, unsaturated polyester resins, and silicone resins; and the like. When the thermosetting resin is cured, a curing agent may be used.

As the photopolymerizable compound, a photopolymerizable monomer, a photopolymerizable oligomer, or a photopolymerizable polymer can be used without particular limitation. Examples of mono functional photopolymerizable monomers include ethyl (meth)acrylate, ethylhexyl (meth)acrylate, styrene, methyl styrene, N-vinylpyrrolidone, and the like. Examples of bi- or multi-functional photopolymerizable monomers include polymethylolpropane tri(meth)acrylate, hexanediol (meth)acrylate, tripropylene glycol di(meth)acrylate, diethylene glycol di(meth)acrylate, pentaerythritol tri(meth)acrylate, pentaerythritol tetra(meth)acrylate, dipentaerythritol penta(meth)acrylate, dipentaerythritol hexa(meth)acrylate, 1,6-hexanediol di(meth)acrylate, neopentyl glycol di(meth)acrylate, and compounds obtained by modifying these compounds with ethylene oxide, polyethylene oxide, and the like.

Each of the compounds may be a compound adjusted to have a high refractive index by introducing an aromatic ring, a halogen atom other than fluorine, a sulfur, nitrogen, or phosphorus atom, or the like. Furthermore, in addition to the compounds described above, comparatively low-molecular-weight polyester resins, polyether resins, acryl resins, epoxy resins, urethane resins, alkyd resins, spiroacetal resins, polybutadiene resins, polythiol-polyene resins, and the like, having unsaturated double bonds, can also be used. When the photopolymerizable compound is polymerized (crosslinked), the polymerization initiator described in the section of the first transparent layer and the second transparent layer may be used.

The first high-refractive-index layer 13 can be formed by, for example, a method similar to the method of forming the first transparent layer 12. Specifically, first, a composition for the first high-refractive-index layer containing at least high-refractive-index fine particles and a photopolymerizable compound is applied to a surface of the first transparent layer 12. Then, the coating film-like composition for the first high-refractive-index layer is dried. Then, the coating film-like composition for a transparent layer is irradiated with light such as ultraviolet light, to polymerize (crosslink) a photopolymerizable compound, whereby the first high-refractive-index layer 13 can be formed.

<First Low-Refractive-Index Layer>

The first low-refractive-index layer 14 is a layer having a lower refractive index than the refractive index of the first high-refractive-index layer 13. It is essential only that the first low-refractive-index layer has a lower refractive index than the refractive index of the first high-refractive-index layer. The first low-refractive-index layer does not have necessarily a lower refractive index than the refractive index of the first transparent layer. Specifically, the refractive index of the first low-refractive-index layer 14 is 1.44 or more and 1.54 or less. The lower limit of the refractive index of the first low-refractive-index layer 14 is preferably 1.47 or more, and the upper limit of the refractive index of the first low-refractive-index layer 14 is preferably 1.51 or less. The refractive index of the first low-refractive-index layer 14 can be measured by a method similar to the method for measuring the refractive index of the first transparent layer 12 described above. The difference between the refractive indices of the first high-refractive-index layer 13 and the first low-refractive-index layer 14 is preferably 0.10 or more and 0.22 or less from the viewpoint of more suppressing a variation of tints.

The film thickness of the first low-refractive-index layer 14 is 3 nm or more and 45 nm or less. The lower limit of the film thickness of the first low-refractive-index layer 14 is preferably 5 nm or more, and the upper limit of the film thickness of the first low-refractive-index layer 14 is preferably 25 nm or less.

The first low-refractive-index layer 14 is not particularly limited as long as the first low-refractive-index layer 14 has the above-described refractive index and the above-described film thickness. The first low-refractive-index layer 14 can include, for example, low-refractive-index particles and a binder resin, or include a low-refractive-index resin.

Examples of the low-refractive-index particles include solid or hollow particles comprising silica or magnesium fluoride; and the like. Of these, hollow silica particles are preferred. Such hollow silica particles can be produced by, for example, a production method described in examples in Japanese Patent Laid-Open No. 2005-099778.

As the fine low-refractive-index particles, reactive fine silica particles having a reactive functional group on a silica surface are preferably used. As the reactive functional group, a photopolymerizable functional group is preferred. Such reactive fine silica particles can be produced by surface treatment of fine silica particles with a silane coupling agent or the like. Examples of methods of treating the surfaces of the fine silica particles with a silane coupling agent include a dry method, a wet method, and the like. The dry method includes spraying a silane coupling agent on fine silica particles. The wet method includes dispersing fine silica particles in a solvent and then adding a silane coupling agent to allow the resultant to react.

Examples of the binder resin included in the first low-refractive-index layer 14 include the same as the binder resin included in the first high-refractive-index layer 13. However, the binder resin may be mixed with a resin, into which a fluorine atom is introduced, or a material having a low refractive index, such as organopolysiloxane.

Examples of the low-refractive-index resin include resins, into which fluorine atoms are introduced, and resins having low refractive indices, such as organopolysiloxane.

The first low-refractive-index layer 14 can be formed by, for example, a method similar to the method of forming the first transparent layer 12. Specifically, first, a composition for the first low-refractive-index layer containing at least low-refractive-index fine particles and a photopolymerizable compound is applied to a surface of the first high-refractive-index layer 13. Then, the coating film-like composition for the first low-refractive-index layer is dried. Then, the coating film-like composition for the first low-refractive-index layer is irradiated with light such as ultraviolet light, to polymerize (crosslink) a photopolymerizable compound, whereby the first low-refractive-index layer 14 can be formed.

Conventionally, the refractive index or film thickness of a low-refractive-index layer or the like in an intermediate base material film has been generally determined from the viewpoint of decreasing the difference (reflectance difference) between the reflectance of the intermediate base material film and the reflectance of the conductive layer layered on the intermediate base material film, and attention has not been focused on a variation of tints from various angles in a case in which the intermediate base material film is viewed. In contrast, the human eye more easily feels a change of tints than the reflectance difference described above, and a variation of tints tends to be increased by increasing the difference between the refractive indices of a high-refractive-index layer and a low-refractive-index layer in order to decrease the difference between the reflectances of an intermediate base material film and a conductive layer. The present inventors extensively repeated research and found that the variation of tints is suppressed by adjusting the a* and b* values of an intermediate base material film. Specifically, it was found by experiment that the variation of tints is not recognized even if an observer views an intermediate base material film from various directions in a case in which when the intermediate base material film is irradiated with light from a first low-refractive-index layer side while an incidence angle is varied every five degrees in a range of 0° or more and 75° or less, assuming that the normal direction of a surface of the intermediate base material film is 0°, to determine a* and b* values in a L*a*b* color system from reflected light toward each regular reflection direction, a variation of the a* values is 1.0 or less, and a variation of the b* values is 1.6 or less. Further, it was found that when a first transparent layer having a refractive index of 1.47 or more and 1.57 or less and a film thickness of 1 μm or more, a first high-refractive-index layer having a refractive index of 1.62 or more and 1.72 or less and a film thickness of 20 nm or more and 80 nm or less, and a first low-refractive-index layer having a refractive index of 1.44 or more and 1.54 or less and a film thickness of 3 nm or more and 45 nm or less are layered in the mentioned order on a transparent base material, the variations of a* and b* values in the intermediate base material film described above can be allowed to be 1.0 or less and 1.6 or less, respectively. In accordance with the present embodiment, when the intermediate base material film 10 is irradiated with light from a side of the first low-refractive-index layer 14 while an incidence angle is varied every five degrees in a range of 0° or more and 75° or less, assuming that the normal direction of a surface of the intermediate base material film 10 is 0°, to determine a* and b* values in a L*a*b* color system from reflected light toward each regular reflection direction, a variation of the a* values is 1.0 or less, a variation of the b* values is 1.6 or less, and therefore, a variation of tints can be suppressed in a case in which the base material film 10 is viewed from various angles. In the intermediate base material film 10 including the first transparent layer 12 having the refractive index and film thickness described above, the first high-refractive-index layer 13 having the refractive index and film thickness described above, and the first low-refractive-index layer 14 having the refractive index and film thickness described above, the difference between the reflectances of the intermediate base material film and the conductive layer is more than the difference between the reflectances of a conventional intermediate base material film and the conductive layer although the difference between the reflectances of the intermediate base material film and the conductive layer is within a permissible range. Therefore, it is not impossible to adopt the intermediate base material film from the viewpoint of decreasing the difference between the reflectances of the intermediate base material film and the conductive layer in such a manner as a conventional manner. Thus, the above-described effects provided by allowing the refractive indices and film thicknesses of the first transparent layer 12, the first high-refractive-index layer 13, and the first low-refractive-index layer 14 to be in the ranges described above, to allow the a* and b* values in the ranges described above, are considered to be prominent effects beyond expectable ranges in light of the technical standards of a conventional intermediate base material film. Although the range of 0° or more and 75° or less is used as the range of an incidence angle in the above description, the above-described effects can be confirmed even in the range of 5° or more and 75° or less. In other words, when the intermediate base material film 10 is irradiated with light from a side of the first low-refractive-index layer 14 while an incidence angle is varied every five degrees in a range of 5° or more and 75° or less, to determine a* and b* values in a L*a*b* color system from reflected light toward each regular reflection direction, a variation of the a* values is 1.0 or less, and a variation of the b* values is 1.6 or less, so that a variation of tints can be confirmed to be suppressed in a case in which the base material film 10 is viewed from various angles.

<<Touch Panel Sensor>>

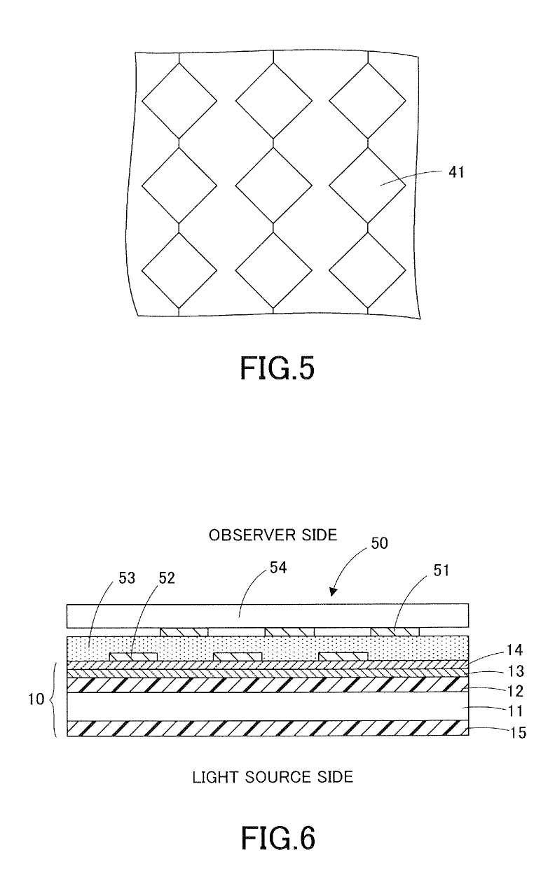

The intermediate base material film 10, which is incorporated into, e.g., a touch panel sensor, can be used. FIG. 3 is a schematic view illustrating the configuration of a touch panel sensor into which the intermediate base material film according to the present embodiment is incorporated, FIG. 4 is a plan view of a portion of the first conductive layer illustrated in FIG. 3, and FIG. 5 is a plan view of a portion of the second conductive layer illustrated in FIG. 3. FIG. 6 is a schematic view illustrating the configuration of another touch panel sensor into which the intermediate base material film according to the present embodiment is incorporated.

The touch panel sensor 20 illustrated in FIG. 3 has a structure in which a first conductive film 30 and a second conductive film 40 are layered. The first conductive film 30 includes: an intermediate base material film 10; first conductive layers 31 supported by the intermediate base material film 10 and subjected to patterning; and a first transparent adhesive layer 32 disposed on the intermediate base material film 10 and the first conductive layers 31. The second conductive film 40 includes: an intermediate base material film 10; second conductive layers 41 supported by the intermediate base material film 10 and subjected to patterning; and a second transparent adhesive layer 42 disposed on the intermediate base material film 10 and the second conductive layers 41.

The first conductive layers 31 and the second conductive layers 41 are not particularly limited as long as the first conductive layers 31 and the second conductive layers 41 are subjected to patterning to have desired shapes, and have electrical conductivity. The first conductive layers 31 and the second conductive layers 41 are connected to terminal portions (not illustrated) via extraction patterns (not illustrated). The shapes of the first conductive layers 31 and the second conductive layers 41 are not particularly limited, and examples thereof include square, rhombus, and stripe shapes. The first conductive layers 31 and the second conductive layers 41 have square shapes as illustrated in FIG. 4 and FIG. 5.

Since the first conductive layers 31 function as electrodes in the X direction of the touch panel sensor 20, pattern shapes included in the first conductive layers 31 are electrically connected in a lateral direction as illustrated in FIG. 4. The first conductive layers 31 are disposed on the first low-refractive-index layer 14 of the intermediate base material film 10 included in the first conductive film 30.

Since the second conductive layers 41 function as electrodes in the Y direction of the touch panel sensor 20, pattern shapes included in the second conductive layers 41 are electrically connected in a longitudinal direction as illustrated in FIG. 5. The second conductive layers 41 are disposed on the first low-refractive-index layer 14 of the intermediate base material film 10 included in the second conductive film 40.

The first conductive layers 31 are placed at portions closer to an observer side than the intermediate base material film 10 included in the first conductive film 30, and the second conductive layers 41 are placed at portions closer to the observer side than the intermediate base material film 10 included in the second conductive film 40. In other words, the second conductive layers 41 are placed between the intermediate base material film 10 included in the first conductive film 30 and the intermediate base material film 10 included in the second conductive film 40. The first conductive film 30 and the second conductive film 40 are affixed to each other with the second transparent adhesive layer 42.

The intermediate base material film 10 may be incorporated into a touch panel sensor according to another embodiment. A touch panel sensor 50 illustrated in FIG. 6 includes an intermediate base material film 10, first conductive layers 51 and second conductive layers 52 which are supported by the intermediate base material film 10 and subjected to patterning, and a transparent adhesive layer 53 where the first conductive layers 51 and the second conductive layers 52 are fixed. The second conductive layers 51 are formed on one surface of a glass plate 54, and the second conductive layers 51 and the glass plate 54 are integrated with each other.

The first conductive layers 51 function as electrodes in the X direction of the touch panel sensor 50 and have pattern shapes similar to those of the first conductive layers 31. The second conductive layers 52 functions as electrodes in the Y direction of the touch panel sensor 50 and have pattern shapes similar to those of the second conductive layers 41. All of the first conductive layers and the second conductive layers 52 are disposed on the first low-refractive-index layer 14 of the intermediate base material film 10.

<First Conductive Layer and Second Conductive Layer>

It is preferable that the first conductive layers 31 and 51 and the second conductive layers 41 and 52 are, for example, transparent conductive layers including a transparent conductive material. Examples of the transparent conductive material include tin-doped indium oxide (ITO), antimony-doped tin oxide (ATO), zinc oxide, indium oxide (In₂O₃), aluminum-doped zinc oxide (AZO), gallium-doped zinc oxide (GZO), tin oxide, and metal oxides based on zinc oxide/tin oxide, indium oxide/tin oxide, zinc oxide/indium oxide/magnesium oxide, and the like. The first conductive layers 31 and 51 and the second conductive layers 41 and 52 are not limited to transparent conductive layers but may be, for example, metal mesh layers subjected to patterning. The metal mesh layer is preferably black-coated with nickel or copper oxide. The black coating can result in suppression of metallic reflection on the metal mesh layer.

As a method for forming the first conductive layers 31 and 51 and the second conductive layers 41 and 52, a sputtering method, a vacuum deposition method, an ion plating method, a CVD method, a coating method, a printing method, or the like can be used without particular limitation. Examples of methods of subjecting the first conductive layers 31 and 51 and second conductive layers 41 and 52 to patterning include a photolithography method.

<Transparent Adhesive Layer>

Examples of the first transparent adhesive layer 32, the second transparent adhesive layer 42, and the adhesive layer 53 include known pressure-sensitive adhesive layers and adhesive sheets.

### Second Embodiment

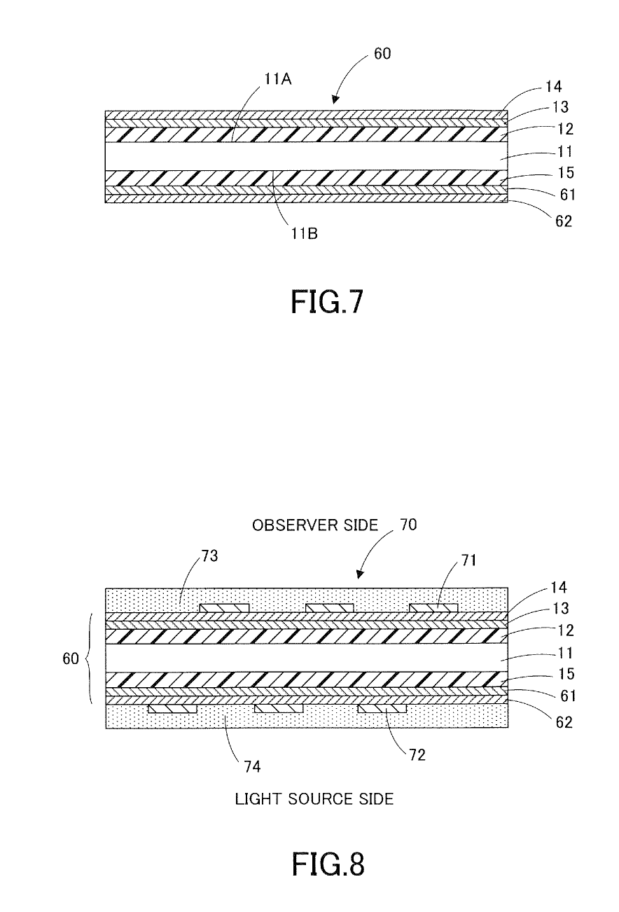

The intermediate base material film and the touch panel sensor according to the second embodiment of the present invention will be described below with reference to the drawings. FIG. 7 is a schematic view illustrating the configuration of the intermediate base material film according to the present embodiment. In the present embodiment, members with the same signs as those of the members described in the first embodiment mean the same members as the members described in the first embodiment, and a content overlapping the first embodiment is omitted unless otherwise specified.

The intermediate base material film 60 illustrated in FIG. 7 includes: a transparent base material 11; a first transparent layer 12 formed on one surface 11A of the transparent base material 11; a first high-refractive-index layer 13 formed on the first transparent layer 12; a first low-refractive-index layer 14 formed on the first high-refractive-index layer 13; a second transparent layer 15 formed on a surface 11B opposite to the one surface 11A of the transparent base material 11; a second high-refractive-index layer 61 formed on the second transparent layer 15; and a second low-refractive-index layer 62 formed on the second high-refractive-index layer 61. In other words, in the intermediate base material film 60, the second high-refractive-index layer 61 and the second low-refractive-index layer 62 are formed on the second transparent layer 15 of the intermediate base material film 10.

The second high-refractive-index layer 61 preferably has a refractive index, a film thickness, and the like equivalent to those of the first high-refractive-index layer 13. In other words, the second high-refractive-index layer 61 preferably has a refractive index of 1.62 or more and 1.72 or less and a film thickness of 20 nm or more and 80 nm or less. Further, the second high-refractive-index layer 61 can include materials similar to those of the first high-refractive-index layer 13.

The second low-refractive-index layer 62 preferably has a refractive index, a film thickness, and the like equivalent to those of the first low-refractive-index layer 14. In other words, the second low-refractive-index layer 62 preferably has a refractive index of 1.44 or more and 1.54 or less and a film thickness of 3 nm or more and 45 nm or less. Further, the second low-refractive-index layer 62 can include materials similar to those of the first low-refractive-index layer 13.

In the intermediate base material film 60, when the intermediate base material film 60 is irradiated with visible light from a side of the first low-refractive-index layer 14 while an incidence angle is varied every five degrees in a range of 0° or more and 75° or less, assuming that the normal direction of a surface of the intermediate base material film 60 is 0°, to determine a* and b* values in a L*a*b* color system from reflected light toward each regular reflection direction, a variation of the a* values is 1.0 or less, and a variation of the b* values is 1.6 or less. The variation of the a* values is preferably 0.4 or less, and the variation of the b* values is preferably 1.55 or less.

In accordance with the present embodiment, the first transparent layer 12 having a refractive index of 1.47 or more and 1.57 or less and a film thickness of 1 μm or more, the first high-refractive-index layer 13 having a refractive index of 1.62 or more and 1.72 or less and a film thickness of 20 nm or more and 80 nm or less, and the first low-refractive-index layer 14 having a refractive index of 1.44 or more and 1.54 or less and a film thickness of 3 nm or more and 45 nm or less are layered in the mentioned order on the transparent base material 11. Therefore, when the intermediate base material film 60 is irradiated with light from a side of to the first low-refractive-index layer 14 while an incidence angle is varied every five degrees in a range of 0° or more and 75° or less, assuming that the normal direction of a surface of the intermediate base material film 60 is 0°, to determine a* and b* values in a L*a*b* color system from reflected light toward each regular reflection direction, the variations of the a* and b* values in the intermediate base material film 60 can be allowed to be 1.0 or less and 1.6 or less, respectively. As a result, a variation of tints can be suppressed in the case of viewing from various angles.

In the intermediate base material film 60, when the intermediate base material film 60 is irradiated with visible light from a side of the second low-refractive-index layer 62 while an incidence angle is varied every five degrees in a range of 0° or more and 75° or less, assuming that the normal direction of a surface of the intermediate base material film 60 is 0°, to determine a* and b* values in L*a*b* color system from reflected light toward each regular reflection direction, a variation of the a* values is preferably 1.0 or less, and a variation of the b* values is preferably 1.6 or less. The variation of the a* values is preferably 0.4 or less, and the variation of the b* values is preferably 1.55 or less. In this case, the variation of the a* values is 1.0 or less, and the variation of the b* values is 1.6 or less, on both surfaces of the base material film 60. Therefore, a variation of tints can be suppressed in the case of viewing from various angles on both surfaces of the base material film 60.

<<Touch Panel Sensor>>

The intermediate base material film 60, which is incorporated into, e.g., a touch panel sensor, can be used. FIG. 8 is a schematic view illustrating the configuration of a touch panel sensor into which the intermediate base material film according to the present embodiment is incorporated.

The touch panel sensor 70 illustrated in FIG. 8 includes: the intermediate base material film 60; first conductive layers 71 and second conductive layers 72 which are supported by the intermediate base material film 60 and subjected to patterning; a first transparent adhesive layer 73 disposed on the intermediate base material film 60 and the first conductive layers 71; and a second transparent adhesive layer 74 disposed on the intermediate base material film 60 and the first conductive layers 72.

The first conductive layers 71 function as electrodes in the X direction of the touch panel sensor 70 and have pattern shapes similar to those of the first conductive layers 31. The first conductive layers 71 are disposed on the first low-refractive-index layer 14 of the intermediate base material film 60. The second conductive layers 72 function as electrodes in the Y direction of the touch panel sensor 70 and have pattern shapes similar to those of the second conductive layers 41. The second conductive layers 72 are disposed on the second low-refractive-index layer 62 of the intermediate base material film 60.

The first conductive layers 71 are placed at positions closer to an observer side than the intermediate base material film 10, and the second conductive layers 72 are placed at positions closer to a light source side than the intermediate base material film 10.

The first conductive layers 71 and the second conductive layers 72 preferably have structures similar to those of the first conductive layers 31 and 51 and the second conductive layers 41 and 52. Further, the first conductive layers 71 and the second conductive layers 72 include materials similar to those of the first conductive layers 31 and 51 and the second conductive layers 41 and 52.

Since the first conductive layers 71 and the second conductive layers 72 are formed on both surfaces of the intermediate base material film 60, the first conductive layers 71 and the second conductive layers 72 can be subjected to patterning by a photolithography method. In this case, the accuracy of the positions of the first conductive layers 71 and the second conductive layers 72 can be enhanced.

### EXAMPLES

The present invention will be described with reference to examples below in order to describe the present invention in detail, but the present invention is not limited to the description thereof.

<Preparation of Composition for Transparent Layer>

First, each constituent was blended so as to have the following composition to obtain a composition for a transparent layer:

(Composition 1 for Transparent Layer)
Pentaerythritol triacrylate (PETA): 30 parts by mass
Polymerization initiator (product name “IRGACURE 184”, manufactured by BASF Japan Ltd.): 1.5 parts by mass
Methyl isobutyl ketone: 70 parts by mass

(Composition 2 for Transparent Layer)
Pentaerythritol triacrylate (PETA): 18 parts by mass
Propylene glycol monomethyl ether acetate (PGMEA): 12 parts by mass
Polymerization initiator (product name “IRGACURE 184”, manufactured by BASF Japan Ltd.): 1.5 parts by mass
Methyl isobutyl ketone: 70 parts by mass

<Preparation of Composition for High-Refractive-Index Layer>

Each constituent was blended so as to have the following composition to obtain a composition for a high-refractive-index layer:

(Composition 1 for High-Refractive-Index Layer)
High-refractive-index fine particle dispersion liquid (dispersion liquid of ZrO₂ fine particles in methyl ethyl ketone (solid content: 30 mass %), product name “MZ-230X” manufactured by Sumitomo Osaka Cement Co., Ltd.): 58.8 parts by mass
Pentaerythritol triacrylate (product name “KAYARAD PET-30”, manufactured by Nippon Kayaku Co., Ltd.): 11.8 parts by mass
Polymerization initiator (product name “IRGACURE 184”, manufactured by BASF Japan Ltd.): 0.6 part by mass
Methyl isobutyl ketone (MIBK): 28.8 parts by mass

(Composition 2 for High-Refractive-Index Layer)
High-refractive-index fine particle dispersion liquid (dispersion liquid of ZrO₂ fine particles in methyl ethyl ketone (solid content: 30 mass %), product name “MZ-230X”, manufactured by Sumitomo Osaka Cement Co., Ltd.): 59.5 parts by mass
Pentaerythritol triacrylate (product name “KAYARAD PET-30”, manufactured by Nippon Kayaku Co., Ltd.): 11.1 parts by mass
Polymerization initiator (product name “IRGACURE 184”, manufactured by BASF Japan Ltd.): 0.6 part by mass
Methyl isobutyl ketone (MIBK): 28.8 parts by mass

(Composition 3 for High-Refractive-Index Layer)
High-refractive-index fine particle dispersion liquid (dispersion liquid of ZrO, fine particles in methyl ethyl ketone (solid content: 30 mass %), product name “MZ-230X”, manufactured by Sumitomo Osaka Cement Co., Ltd.): 59.9 parts by mass
Pentaerythritol triacrylate (product name “KAYARAD PET-30”, manufactured by Nippon Kayaku Co., Ltd.): 10.7 parts by mass
Polymerization initiator (product name “IRGACURE 184”, manufactured by BASF Japan Ltd.): 0.6 part by mass
Methyl isobutyl ketone (MIBK): 28.8 parts by mass

(Composition 4 for High-Refractive-Index Layer)
High-refractive-index fine particle dispersion liquid (dispersion liquid of ZrO₂ fine particles in methyl ethyl ketone (solid content: 30 mass %), product name “MZ-230X”, manufactured by Sumitomo Osaka Cement Co., Ltd.): 62.0 parts by mass
Pentaerythritol triacrylate (product name “KAYARAD PET-30”, manufactured by Nippon Kayaku Co., Ltd.): 8.6 parts by mass
Polymerization initiator (product name “IRGACURE 184”, manufactured by BASF Japan Ltd.): 0.6 part by mass
Methyl isobutyl ketone (MIBK): 28.8 parts by mass

<Preparation of Composition for Low-Refractive-Index Layer>

Each constituent was blended so as to have the following composition to obtain a composition for a low-refractive-index layer:

(Composition 1 for Low-Refractive-Index Layer)
Hollow fine silica particles (dispersion liquid of hollow fine silica particles in methyl isobutyl ketone (solid content: 20 mass %)): 40 parts by mass
Pentaerythritol triacrylate (PETA) (product name “PETIA”, manufactured by DAICEL-CYTEC Co., Ltd.): 10 parts by mass
Polymerization initiator (product name “IRGACURE 127”, manufactured by BASF Japan Ltd.): 0.35 part by mass
Modified silicone oil (product name “X22164E”, manufactured by Shin-Etsu Chemical Co., Ltd.): 0.5 part by mass
Methyl isobutyl ketone (MIRK): 320 parts by mass
Propylene glycol monomethyl ether acetate (PGMEA): 161 parts by mass

(Composition 2 for Low-Refractive-Index Layer)
Hollow fine silica particles (dispersion liquid of hollow fine silica particles in methyl isobutyl ketone (solid content: 20 mass %)): 40.5 parts by mass
Pentaerythritol triacrylate (PETA) (product name “PETIA”, manufactured by DAICEL-CYTEC Co., Ltd.): 9.5 parts by mass
Polymerization initiator (product name “IRGACURE 127”, manufactured by BASF Japan Ltd.): 0.35 part by mass
Modified silicone oil (product name “X22164E”, manufactured by Shin-Etsu Chemical Co., Ltd.): 0.5 part by mass
Methyl isobutyl ketone (MIBK): 320 parts by mass
Propylene glycol monomethyl ether acetate (PGMEA): 161 parts by mass

(Composition 3 for Low-Refractive-Index Layer)
Hollow fine silica particles (dispersion liquid of hollow fine silica particles in methyl isobutyl ketone (solid content: 20 mass %)): 41 parts by mass
Pentaerythritol triacrylate (PETA) (product name “PETIA”, manufactured by DAICEL-CYTEC Co., Ltd.): 9 parts by mass
Polymerization initiator (product name “IRGACURE 27”, manufactured by BASF Japan Ltd.): 0.35 part by mass
Modified silicone oil (product name “X22164E”, manufactured by Shin-Etsu Chemical Co., Ltd.): 0.5 part by mass
Methyl isobutyl ketone (MIBK): 320 parts by mass
Propylene glycol monomethyl ether acetate (PGMEA): 161 parts by mass

(Composition 4 for Low-Refractive-Index Layer)
Hollow fine silica particles (dispersion liquid of hollow fine silica particles in methyl isobutyl ketone (solid content: 20 mass %)): 38.4 parts by mass
Pentaerythritol triacrylate (PETA) (product name “PETIA”, manufactured by DAICEL-CYTEC Co., Ltd.): 8.4 parts by mass
Polymerization initiator (product name “IRGACURE 127”, manufactured by BASF Japan Ltd.): 0.35 part by mass
Modified silicone oil (product name “X22164E”, manufactured by Shin-Etsu Chemical Co., Ltd.): 0.5 part by mass
Methyl isobutyl ketone (MIBK): 320 parts by mass
Propylene glycol monomethyl ether acetate (PGMEA): 161 parts by mass

(Composition 5 for Low-Refractive-Index Layer)
Hollow fine silica particles (dispersion liquid of hollow fine silica particles in methyl isobutyl ketone (solid content: 20 mass %)): 35.7 parts by mass
Pentaerythritol triacrylate (PETA) (product name “PETIA”, manufactured by DAICEL-CYTEC Co., Ltd.): 5.7 parts by mass
Polymerization initiator (product name “IRGACURE 127”, manufactured by BASF Japan Ltd.): 0.35 part by mass
Modified silicone oil (product name “X22164E”, manufactured by Shin-Etsu Chemical Co., Ltd.): 0.5 part by mass
Methyl isobutyl ketone (MIBK): 320 parts by mass
Propylene glycol monomethyl ether acetate (PGMEA): 161 parts by mass

### Example 1

A polyethylene terephthalate base material (product name “COSMOSHINE”, manufactured by TOYOBO CO., LTD.) having a refractive index of 1.62 and a thickness of 125 μm was prepared as a transparent base material, and the composition 1 for a transparent layer was applied to both surfaces of the polyethylene terephthalate base material, to form coating films. Then, a solvent in the coating films was evaporated by circulating dry air at 50° C. to the formed coating films at a flow rate of 0.2 m/s for 15 seconds and thereafter further circulating dry air at 70° C. at a flow rate of 10 m/s for 30 seconds to dry the coating films, and transparent layers having a refractive index of 1.52 and a film thickness of 4.5 μm were formed by irradiating the coating films with ultraviolet light under nitrogen atmosphere (oxygen concentration of 200 ppm or less) so that the integrated amount of light was 100 mJ/cm² to cure the coating films. Then, the composition 1 for a high-refractive-index layer was applied onto each transparent layer, to form a coating film. In addition, the formed coating film was dried at 40° C. for 1 minute and thereafter irradiated with ultraviolet light at an integrated amount of light of 100 mJ/cm² under nitrogen atmosphere (oxygen concentration of 200 ppm or less), to cure the coating film and to form a high-refractive-index layer having a refractive index of 1.67 and a film thickness of 50 nm. Then, the composition 1 for a low-refractive-index layer was applied onto each high-refractive-index layer, to form a coating film. In addition, the formed coating film was dried at 40° C. for 1 minute and thereafter irradiated with ultraviolet light at an integrated amount of light of 100 mJ/cm² under nitrogen atmosphere (oxygen concentration of 200 ppm or less), to cure the coating film, to form a low-refractive-index layer having a refractive index of 1.49 and a film thickness of 20 nm, and to produce an intermediate base material film according to Example 1.

### Example 2

In Example 2, an intermediate base material film was produced in the same manner as in Example 1 except that a composition 2 for a high-refractive-index layer and a composition 2 for a low-refractive-index layer were used instead of the composition 1 for a high-refractive-index layer and the composition 1 for a low-refractive-index layer. The base material film according to Example 2 included a high-refractive-index layer having a refractive index of 1.69 and a low-refractive-index layer having a refractive index of 1.51.

### Example 3

In Example 3, an intermediate base material film was produced in the same manner as in Example 1 except that a composition 2 for a transparent layer, a composition 3 for a high-refractive-index layer, and a composition 3 for a low-refractive-index layer were used instead of the composition 1 for a transparent layer, the composition 1 for a high-refractive-index layer, and the composition 1 for a low-refractive-index layer and that the film thickness of a high-refractive-index layer was 60 nm. The base material film according to Example 3 included a transparent layer having a refractive index of 1.53, the high-refractive-index layer having a refractive index of 1.70, and a low-refractive-index layer having a refractive index of 1.53.

### Comparative Example 1

In Comparative Example 1, an intermediate base material film was produced in the same manner as in Example 1 except that the composition 2 for a transparent layer, a composition 4 for a high-refractive-index layer, and the composition 3 for a low-refractive-index layer were used instead of the composition 1 for a transparent layer, the composition 1 for a high-refractive-index layer, and a composition 1 for a low-refractive-index layer, and that the film thickness of a high-refractive-index layer was 60 nm. The base material film according to Comparative Example 1 included a transparent layer having a refractive index of 1.53, the high-refractive-index layer having a refractive index of 1.76, and a low-refractive-index layer having a refractive index of 1.53.

### Comparative Example 2

In Comparative Example 2, an intermediate base material film was produced in the same manner as in Example 1 except that the composition 2 for a transparent layer, the composition 4 for a high-refractive-index layer, and a composition 4 for a low-refractive-index layer were used instead of the composition 1 for a transparent layer, the composition 1 for a high-refractive-index layer, and a composition 1 for a low-refractive-index layer, that the film thickness of a high-refractive-index layer was 65 nm, and that the film thickness of a low-refractive-index layer was 30 nm. The base material film according to Comparative Example 2 included a transparent layer having a refractive index of 1.53, the high-refractive-index layer having a refractive index of 1.76, and the low-refractive-index layer having a refractive index of 1.43.

### Comparative Example 3

In Comparative Example 3, an intermediate base material film was produced in the same manner as in Example 1 except that the composition 2 for a high-refractive-index layer and a composition 5 for a low-refractive-index layer were used instead of the composition 1 for a high-refractive-index layer and the composition 1 for a low-refractive-index layer, that the film thickness of a high-refractive-index layer was 65 nm, and the film thickness of a low-refractive-index layer was 30 nm. The base material film according to Comparative Example 3 included the high-refractive-index layer having a refractive index of 1.76 and the low-refractive-index layer having a refractive index of 1.33.

<Variation of a* and b*>

The variations of a* and b* of each intermediate base material him obtained in the examples and the comparative examples were determined in a manner as described below. Specifically, each intermediate base material film was irradiated with light from a side of the low-refractive-index layer while an incidence angle was varied every 5° in a range of 5° to 75°, to obtain a* and b* values from reflected light toward each regular reflection direction, using VAR-7010 manufactured by JASCO Corporation. The measurement conditions were as described below. The measurement was performed to receive regularly reflected light in synchronization between an incidence angle and the position of a detector at a data acquisition spacing of 1 nm in a measurement range of 380 nm to 780 nm, using a deuterium (D2) lamp and a tungsten halogen (WI) lamp as light sources and using a polarizer of which the transmission axis was inclined at 45°. Further, each intermediate base material film was irradiated with light at an incidence angle of 0° from a side of the low-refractive-index layer, to determine a* and b* values from reflected light toward each regular reflection direction in simulation. Specifically, the a* and b* values at an incidence angle of 0° in simulation were determined from the refractive index layer and film thickness of each layer using the 2-degree visual field color matching function defined in CIE 1931. In addition, the absolute values of the differences between the maximum and minimum values of the obtained a* and b* values at each incidence angle were calculated to determine the variations of the a* values and the variations of the b* values.

<Variation of Tints>

It was evaluated whether the tint of each intermediate base material film varied or not when each intermediate base material film obtained in the examples and the comparative examples was viewed from various directions. The evaluation criteria were as follows:

Good: No variation of tints was able to be confirmed.

Poor: A variation of tints was able to be confirmed.

The results are listed in Table 1 to Table 3 below.

TABLE 1

| | 0° | | 5° | | 10° | | 15° | | 20° | | 25° | | 30° | | 35° | |
|---|---|---|---|---|---|---|---|---|---|---|---|---|---|---|---|---|
| | a* | b* | a* | b* | a* | b* | a* | b* | a* | b* | a* | b* | a* | b* | a* | b* |
| Example 1 | 0.38 | −0.59 | 0.37 | −0.59 | 0.44 | −0.59 | 0.54 | −0.53 | 0.57 | −0.44 | 0.52 | −0.23 | 0.44 | −0.01 | 0.43 | 0.1 |
| Example 2 | 0.43 | −0.62 | 0.42 | −0.62 | 0.50 | −0.62 | 0.62 | −0.56 | 0.65 | −0.46 | 0.59 | −0.24 | 0.50 | −0.01 | 0.49 | 0.11 |
| Example 3 | 0.52 | −0.67 | 0.50 | −0.67 | 0.54 | −0.67 | 0.73 | −0.62 | 0.77 | −0.52 | 0.71 | −0.27 | 0.60 | −0.01 | 0.58 | 0.12 |
| Comparative | −0.48 | 0.34 | −0.48 | 0.29 | −0.48 | 0.14 | −0.48 | −0.09 | −0.47 | −0.39 | −0.46 | −0.76 | −0.45 | −1.16 | −0.42 | −1.58 |
| Example 1 | | | | | | | | | | | | | | | | |
| Comparative | −0.47 | 0.43 | −0.48 | 0.36 | −0.46 | 0.18 | −0.47 | −0.11 | −0.47 | −0.49 | −0.46 | −0.95 | −0.45 | −1.45 | −0.41 | −1.98 |
| Example 2 | | | | | | | | | | | | | | | | |
| Comparative | −0.49 | 0.51 | −0.48 | 0.44 | −0.46 | 0.21 | −0.50 | −0.14 | −0.48 | −0.59 | −0.45 | −1.15 | −0.46 | −1.76 | −0.42 | −2.39 |
| Example 3 | | | | | | | | | | | | | | | | |

TABLE 2

| | 40° | | 45° | | 50° | | 55° | | 60° | | 65° | | 70° | | 75° | |
|---|---|---|---|---|---|---|---|---|---|---|---|---|---|---|---|---|
| | a* | b* | a* | b* | a* | b* | a* | b* | a* | b* | a* | b* | a* | b* | a* | b* |
| Example 1 | 0.52 | 0.14 | 0.62 | 0.34 | 0.59 | 0.55 | 0.46 | 0.62 | 0.4 | 0.68 | 0.34 | 0.72 | 0.35 | 0.68 | 0.41 | 0.71 |
| Example 2 | 0.59 | 0.15 | 0.71 | 0.36 | 0.67 | 0.53 | 0.53 | 0.65 | 0.46 | 0.71 | 0.39 | 0.73 | 0.40 | 0.71 | 0.47 | 0.72 |
| Example 3 | 0.71 | 0.16 | 0.84 | 0.40 | 0.80 | 0.65 | 0.62 | 0.73 | 0.54 | 0.80 | 0.46 | 0.85 | 0.47 | 0.80 | 0.56 | 0.84 |
| Comparative | −0.39 | −1.96 | −0.35 | −2.66 | −0.31 | −2.56 | −0.26 | −2.69 | −0.21 | −2.68 | −0.15 | −2.49 | −0.06 | −2.47 | −0.03 | −2.48 |
| Example 1 | | | | | | | | | | | | | | | | |
| Comparative | −0.38 | −2.46 | −0.34 | −3.36 | −0.3 | −3.21 | −0.25 | −3.37 | −0.2 | −3.36 | −0.16 | −3.12 | −0.05 | −3.1 | −0.04 | −3.11 |
| Example 2 | | | | | | | | | | | | | | | | |
| Comparative | −0.38 | −2.97 | −0.35 | −4.03 | −0.33 | −3.88 | −0.24 | −4.08 | −0.19 | −4.06 | −0.17 | −3.77 | −0.07 | −3.74 | −0.02 | −3.76 |
| Example 3 | | | | | | | | | | | | | | | | |

TABLE 3

| | Variation of | Variation of | Variation of |
|---|---|---|---|
| | a* values | b* values | tints |
| Example 1 | 0.28 | 1.29 | Good |
| Example 2 | 0.32 | 1.35 | Good |
| Example 3 | 0.38 | 1.52 | Good |
| Comparative | 0.45 | 3.03 | Poor |
| Example 1 | | | |
| Comparative | 0.44 | 3.80 | Poor |
| Example 2 | | | |
| Comparative | 0.48 | 4.59 | Poor |
| Example 3 | | | |

As listed in Table 3, in the intermediate base material films of Comparative Examples 1 to 3, the variations of the tints were not able to be suppressed since the requirement that the variation of a* values is 1.0 or less and the variation of b* values is 1.6 or less was not satisfied.

In contrast, in the intermediate base material films of Examples 1 to 3, the variation of the tints were able to be suppressed since the requirement that the variation of a* values is 1.0 or less and the variation of b* values is 1.6 or less was satisfied.

### EXPLANATION OF REFERENCE NUMERALS

10: Intermediate base material film
11: Transparent base material
11A: Surface
11B: Surface
12: First transparent layer
13: First high-refractive-index layer
14: First low-refractive-index layer
15: Second transparent layer
20: Touch panel sensor
31: First conductive layer
41: Second conductive layer
50: Touch panel sensor
51: First conductive layer
52: Second conductive layer
60: Intermediate base material film
61: Second high-refractive-index layer
62: Second low-refractive-index layer
71: First conductive layer
72: Second conductive layer
80: Touch panel sensor

What is claimed is:

1. An intermediate substrate film for supporting a conductive layer subjected to patterning, the intermediate substrate comprising:
a transparent substrate;
a first high-refractive-index layer that is layered on one surface of the transparent substrate; and
a first low-refractive-index layer that is layered on the first high-refractive-index layer and has a lower refractive index than a refractive index of the first high-refractive-index layer,
wherein when the intermediate substrate film is irradiated with light from a first low-refractive-index layer side while an incidence angle is varied every five degrees in a range of 0° or more and 75° or less, assuming that a normal direction of a surface of the intermediate substrate film is 0°, to determine a* and b* values in a L*a*b* color system from reflected light toward each regular reflection direction, a variation of the a* value is 1.0 or less, and a variation of the b* value is 1.6 or less.

2. The intermediate substrate film according to claim 1, wherein a difference between refractive indices of the first high-refractive-index layer and the first low-refractive-index layer is 0.10 or more and 0.22 or less.

3. The intermediate substrate film according to claim 1, wherein the first high-refractive-index layer has a film thickness of 20 nm or more and 80 nm or less and a refractive index of 1.62 or more and 1.72 or less; and the first low-refractive-index layer has a film thickness of 3 nm or more and 45 nm or less and a refractive index of 1.44 or more and 1.54 or less.

4. The intermediate substrate film according to claim 1, further comprising a first transparent layer having a refractive index of 1.47 or more and 1.57 or less between the transparent substrate and the first high-refractive-index layer.

5. The intermediate substrate film according to claim 4, wherein the first transparent layer has a film thickness of 1 μm or more.

6. The intermediate substrate film according to claim 1, further comprising:
a second high-refractive-index layer that is layered on a surface opposite to the one surface of the transparent substrate; and
a second low-refractive-index layer that is layered on the second high-refractive-index layer and has a lower refractive index than a refractive index of the second high-refractive-index layer.

7. A touch panel sensor comprising:
the intermediate substrate film according to claim 1; and
a first conductive layer that is layered on the first low-refractive-index layer of the intermediate substrate film and is subjected to patterning.

8. A touch panel sensor comprising:
the intermediate substrate film according to claim 6;
a first conductive layer that is layered on the first low-refractive-index layer of the intermediate substrate film and is subjected to patterning; and
a second conductive layer that is layered on the second low-refractive-index layer of the intermediate substrate film and is subjected to patterning.
